(19) United States
(12) Patent Application Publication
(10) Pub. No.: US 2014/0323167 A1
(43) Pub. Date: Oct. 30, 2014

(54) MESSAGING METHOD AND SYSTEM

(71) Applicant: ApproachPlus Pty Ltd, Armadale (AU)

(72) Inventors: Ross Donald Spearritt, Armadale (AU); Tim Patrick MacNamara, Singapore (SG)

(73) Assignee: ApproachPlus Pty Ltd, Armadale (AU)

(21) Appl. No.: 14/264,717

(22) Filed: Apr. 29, 2014

(30) Foreign Application Priority Data
Apr. 29, 2013 (AU) 2013901483

(51) Int. Cl. H04W 4/14

(52) U.S. Cl. CPC H04W 4/14
USPC 455/466

(57) ABSTRACT

A method for providing an auxiliary response to a user of a primary service and a primary response to the user, the method comprising the steps of: receiving a request from the user, the request being in respect of the primary service, and comprising location information; determining the primary response, the primary response based on the location information and the primary service; determining the auxiliary response, the auxiliary response based on the location information; and communicating the primary response and the auxiliary response to the user, wherein the auxiliary response comprises information in respect of an auxiliary entity.

### FIELD OF THE INVENTION

The invention relates to providing location relevant information to a service user.

### BACKGROUND TO THE INVENTION

When a taxi is requested to pickup a customer from the customer's location, there can be delays caused due to the customer not being ready and in position to be picked up by the taxi upon arrival at the pickup location. This occurs, for example, because the customer is within a building and unable to see the arrival of the taxi. Compounding the delay is that, when a taxi is booked, at best an approximate pickup time can be provided, which may be incongruent with the actual arrival time of the taxi.

It is known to provide a service of SMS messaging the customer when the taxi is within a predefined distance and/or time of arrival, the SMS message comprising simply a message stating that the taxi is near.

### SUMMARY OF THE INVENTION

According to an aspect of the present invention, there is provided a method for providing an auxiliary response to a user of a primary service and a primary response to the user, the method comprising the steps of: receiving a request from the user, the request being in respect of the primary service, and comprising location information; determining the primary response, the primary response based on the location information and the primary service; determining the auxiliary response, the auxiliary response based on the location information; and communicating the primary response and the auxiliary response to the user, wherein the auxiliary response comprises information in respect of an auxiliary entity.

In embodiments, the request corresponds to a request for the primary service to be provided by a primary entity.

Preferably, the content of the primary response is independent of the content of the auxiliary response. Typically, the primary response provides information about the primary service of the primary entity, whereas the auxiliary response provides information related to a different entity, namely the auxiliary entity, and a service or services provided by the auxiliary entity.

The primary service may be a taxi service, and the primary response may be an SMS message informing the user that a taxi of the taxi service is arriving, and the auxiliary response may be an advertisement for the auxiliary entity. Alternatively, instead of an SMS message, the primary response may be a notification. The auxiliary response may be incorporated into the primary response. Optionally, the auxiliary response is appended to the primary response. Alternatively, the auxiliary response is sent separately to the primary response. The auxiliary response may be sent at or after completion of the primary service.

In embodiments, the auxiliary response is determined by selecting an auxiliary response from a response group. Each auxiliary response within the response group may have an associated geographic region. The auxiliary response with a closest geographic region to the location information may be selected. The selection of an auxiliary response may further comprise a bidding step. Optionally, the selection of an auxiliary response further comprises a filtering step.

In an embodiment, the location information includes a pickup location. Alternatively, in an embodiment, the location information includes a destination location.

Optionally, the filtering step includes the steps of: identifying a response time associated with the request; identifying one or more auxiliary responses having an associated time of day and/or day of week corresponding to the response time; and limiting the response group such that only said identified one or more auxiliary responses are present within the response group.

The communication of the primary response and auxiliary response to the user may include a wireless communication.

According to another aspect of the present invention, there is provided a system comprising at least one processor and a memory, wherein the processor is configured for executing instructions stored within the memory, and wherein the memory comprises instructions for: receiving a request from the user, the request being in respect of the primary service, and comprising location information; determining a primary response, the primary response based on the location information and the primary service; determining an auxiliary response, the auxiliary response based on the location information; and communicating the primary response and the auxiliary response to the user, wherein the auxiliary response comprises information in respect of an auxiliary entity.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIG. 1 shows a exemplary computer network in which embodiments can be implemented;

FIG. 2 shows a server communicating an SMS message to a mobile device;

FIG. 3 shows a prior art method for delivering an SMS arrival message;

FIG. 4 shows a method for communicating an auxiliary response according to the present invention;

FIG. 5 shows selecting one auxiliary response from a response group;

FIG. 6 shows the method of FIG. 4 with the auxiliary response step including a filtering step and a decision making step;

FIG. 7 shows first filtering an extended response group to arrive at a response group, before selecting one auxiliary response; and

FIGS. 8a to 8d show an example method for a user to create an auxiliary response.

### DESCRIPTION OF PREFERRED EMBODIMENT

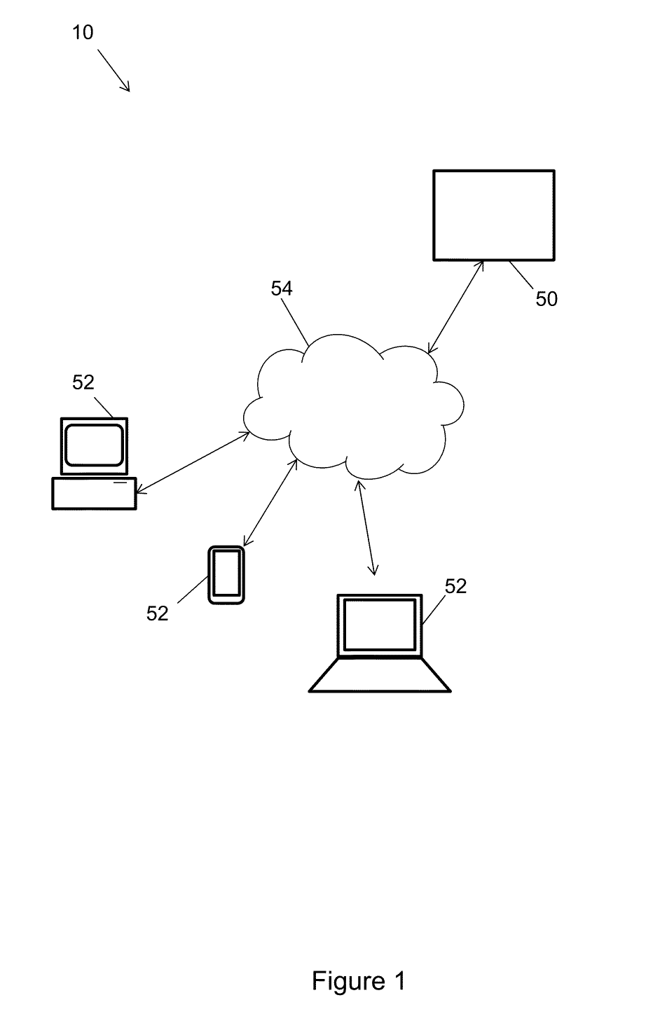

FIG. 1 illustrates an exemplary system 10 in which preferred embodiments of the invention may be implemented. The system 10 includes a server 50 and user terminals 52, each of which is connected to a network 52, which may be, for example, the Internet. It will be appreciated that FIG. 1 depicts the system 10 schematically only, and is not intended to limit the technology employed in the server 50, user terminals 52 and/or communications links. The user terminals 52 in particular may be wired or wireless devices, and their connections to the network may utilize various technologies and bandwidths. For example, applicable user terminals 52 include (without limitation): PC's with wired (e.g. LAN, cable, ADSL, dial-up) or wireless (e.g. WLAN, cellular) connections; and wireless portable/handheld devices such as PDA's or mobile/cellular telephones. The protocols and interfaces between the user terminals 52 and the server 50 may also vary according to available technologies, and include (again without limitation): wired TCP/IP (Internet) protocols; GPRS, WAP and/or 3G protocols (for handheld/cellular devices); Short Message Service (SMS) messaging for digital mobile/cellular devices; and/or proprietary communications protocols.

The server 50 can be a single device or a plurality of interconnected devices, and includes at least one processor as well as a database, which would typically be stored on a secondary storage device of the server 50, such as one or more hard disk drives. Server 50 further includes at least one storage medium, typically being a suitable type of memory, such as random access memory, for containing program instructions and transient data related to the implementation of the invention as well as other necessary functions of the server 50. In particular, the memory contains a body of program instructions.

It should be appreciated that the hardware used to implement the method of the invention may be conventional in nature or specifically designed for the purpose. The hardware structure shown in FIG. 1 is merely one possible embodiment and any other suitable structure may be utilised.

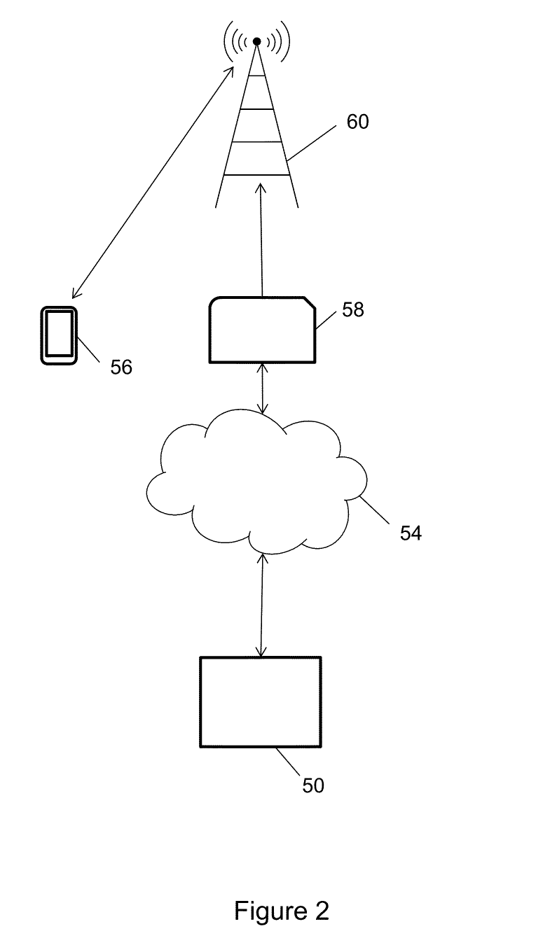

Referring to FIG. 2, the server 50 is configured to send messages in the form of SMS messages to mobile devices 56 (i.e. user terminals 52 configured for mobile use), such as mobile phones, for example smartphones. Generally, the server 50 is configured to prepare the SMS message, and to forward it via the network 54 to a mobile phone service provider 58. The mobile phone service provider 58 then communicates the SMS message to a mobile phone 56 via a cellular radio tower 60.

Embodiments of the invention will be described with reference to an SMS messaging service associated with booking of a vehicle for hire (primary service), e.g. a taxicab (taxi). Typically, when a taxi is booked, the customer (a user) specifies to an operator of a taxi company (a primary entity) a pickup location and often a destination location. A taxi will then be despatched to pick up the customer, and after doing so the taxi will transport the customer to the destination location at which point the customer pays the fare and departs. It is understood that any suitable digital communication technology for providing a message to a customer can be utilised in place of, or in conjunction with, the SMS messaging service. For embodiments described herein, the server 50 is operated by a service provider, and the primary entity (i.e. the taxi company) is a client of the servicer provider.

One alternative to a SMS messaging service is a notification service, which can be particularly applicable when the mobile phone 56 is a smart phone. Smart phones can receive, from the server 50, an instruction to present a notification to the customer through the smart phone interface (e.g. a screen). Such a notification can be visual and/or audible. It is understood that both SMS messaging and notifications can be utilised by the server 50. Typically, the notification service operates via a data network such as the Internet, and may therefore utilise 3G or 4G mobile systems.

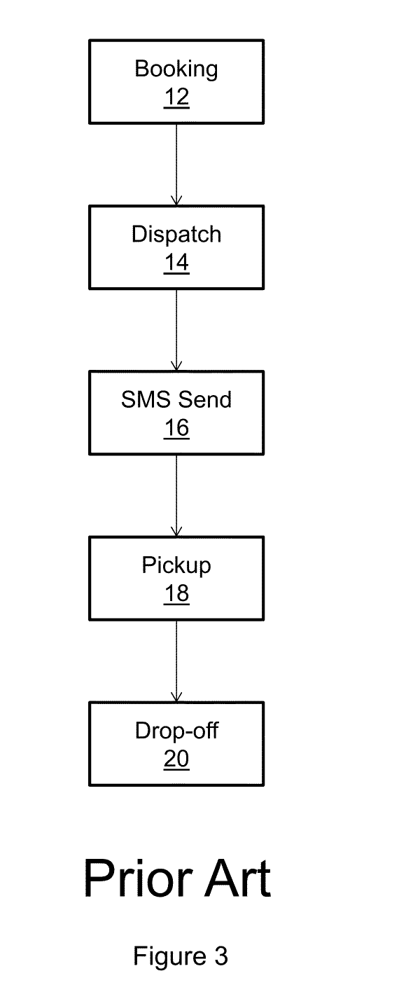

Prior art SMS messaging systems used by taxi companies comprise a method for sending an SMS message to the customer when a taxicab is close to picking up the customer. As shown in FIG. 3, first the customer books a taxi by contacting an operator of the taxi company, at booking step 12. The customer order comprises, as stated previously, a pickup location. At dispatch step 14, a taxi is dispatched by the operator to the pickup location. When the taxi is within a predetermined distance (or, similarly, a predetermined time-to-destination) of the pickup location, an SMS arrival alert message (primary response) is sent to the customer at SMS step 16. The SMS message comprises text informing the customer that the taxi is close to arriving at the pickup location, thus enabling the customer to prepare (e.g. by waiting outside). At pickup step 18, the customer is picked up at the pickup location by the taxi, and then transported to the destination location at drop-off step 20.

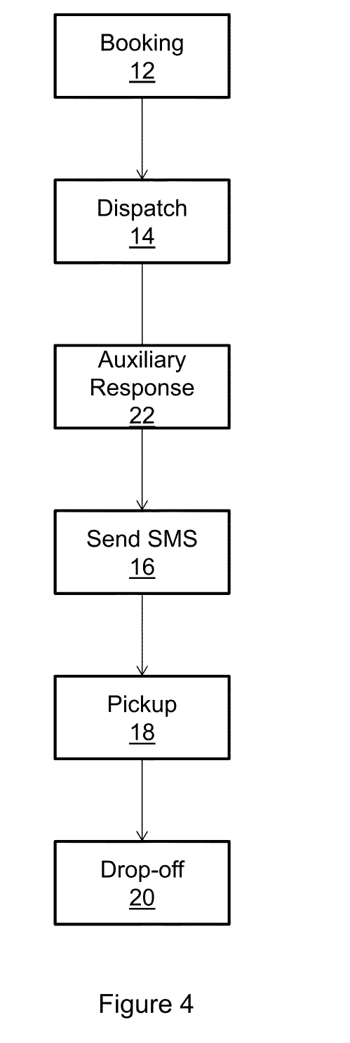

According to embodiments of the present invention, as shown with reference to FIGS. 4 to 7, an auxiliary response 30 is generated at auxiliary response step 22 and sent along with the SMS arrival alert message at SMS step 16. It is understood that the auxiliary response 30 can be added to, for example appended to or inserted within, the SMS arrival alert message, sent as a separate SMS message, or otherwise communicated to the customer.

The auxiliary response 30 comprises information related to an auxiliary entity, which is an entity different to the primary entity. Herein, the auxiliary response 30 is a text advertisement for an auxiliary entity, the auxiliary entity being an advertiser. The advertisement can comprise an interactive element, for example a hyperlink. The hyperlink can be configured for, when activated, displaying a webpage to the customer. Further, the hyperlink can be configured to cause a web browser to contact the service provider, thus enabling the service provider to maintain a record of the rate at which hyperlinks are accessed per advert. The advertisement can also, or alternatively, comprise a voucher offered by the advertising partner.

An example of a primary response according to an embodiment is:
Cab 1234 is approaching. Please go to your pickup.

An example of an axillary response 30 according to an embodiment is:
TRIP BONUS: Show this message at FOOD PLAZA, and get lunch to the value of $20. Visit: http://voucheraddress.com for further details. Offer expires 7 days from receipt of this message.

The resulting SMS arrival alert message, which comprises both the primary response and auxiliary response 30, is according to this example:
Cab 1234 is approaching. TRIP BONUS: Show this message at FOOD PLAZA, and get lunch to the value of $20. Visit: http://voucheraddress.com for further details. Offer expires 7 days from receipt of this message. Please go to your pickup.

As can be seen, the auxiliary response 30 in this example was inserted within the primary message.

The auxiliary response 30 is determined based on at least location information provided by the customer to the taxi company. The location information can include the pickup location and/or the destination location and/or any other suitable location information related to the primary service

For example, the location information is determined based on at least the intended pickup location and/or the destination location, such as provided by the customer to the taxi company when booking the taxi.

Alternatively, or in combination, the auxiliary response 30 is determined based on at least the actual pickup location and/or destination location. For example, the location information may be determined and provided by the taxi. For example, the location information is determined by a device present within the taxi (such as a GPS unit). This embodiment may be advantageous, for example, as it allows for the customer to change the drop-off location during the trip. This embodiment may be particularly applicable to implementations where the auxiliary response 30 is communicated separately to the primary response.

For the purposes of the present disclosure, it will be assumed that the location information is the pickup location.

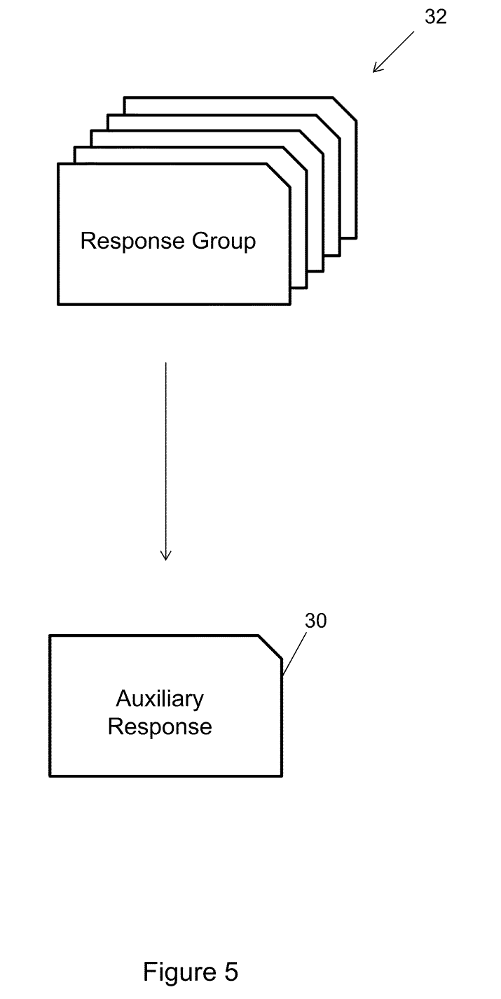

Referring to FIG. 5, an auxiliary response 30 is selected from a response group 32 including a plurality of auxiliary responses 30. The response group 32 can comprise a plurality of auxiliary responses 30 of one auxiliary entity, or, more preferably, a plurality of auxiliary responses 30 from a plurality of auxiliary entities. Each auxiliary response 30 has associated with it a geographic region. Example geographic regions are: an area code, town, suburb, or distance from a particular geographic co-ordinate (e.g. a store location).

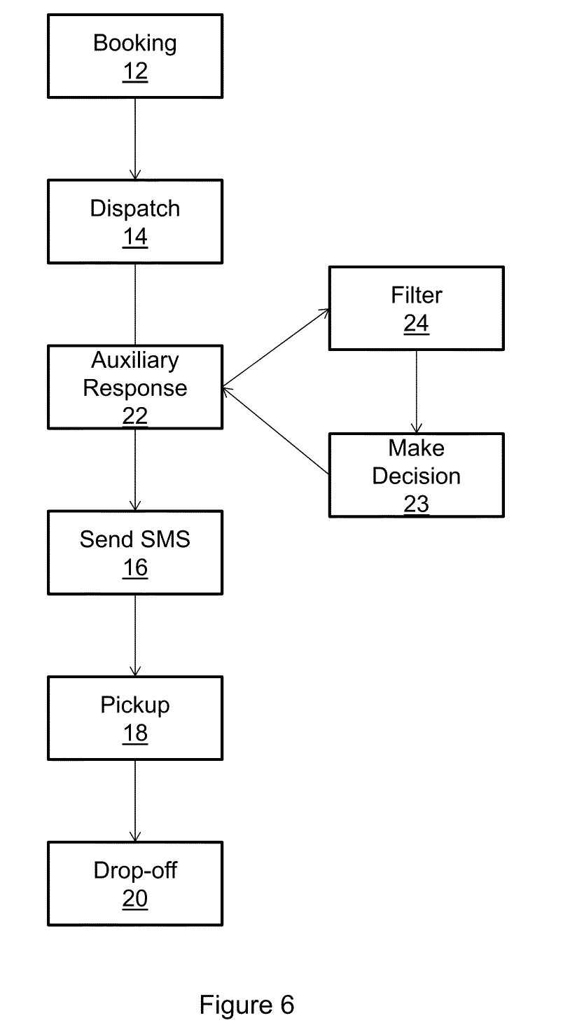

The auxiliary response step 22 corresponds to a determination being made of which auxiliary response 30 from the response group 32 has an associated geographic region encompassing the pickup location. In situations where there are a plurality of auxiliary responses 30 with a geographic region encompassing the pickup location, a decision making step 23 is performed to select one of the plurality of auxiliary responses 30. The, or each, auxiliary response 30 with a geographic region encompassing the pickup location therefore meets the geographic requirements of the auxiliary response step 22. FIG. 6 shows the auxiliary response step 22 including a decision making step 23 and a filtering step 24, as described below.

The geographic region associated with an auxiliary response 30 can also be a specific location, for example a business address or GPS co-ordinate. The auxiliary response step 22 in this case corresponds to a determination being made of the auxiliary response 30 with the closest geographic region to the pickup location. Instead of identifying the auxiliary response 30 with the closest geographic region to the pickup location, one or more auxiliary responses 30 with a geographic region within a predefined distance can be identified, followed by a decision making step 23 in order to select one of the auxiliary responses 30.

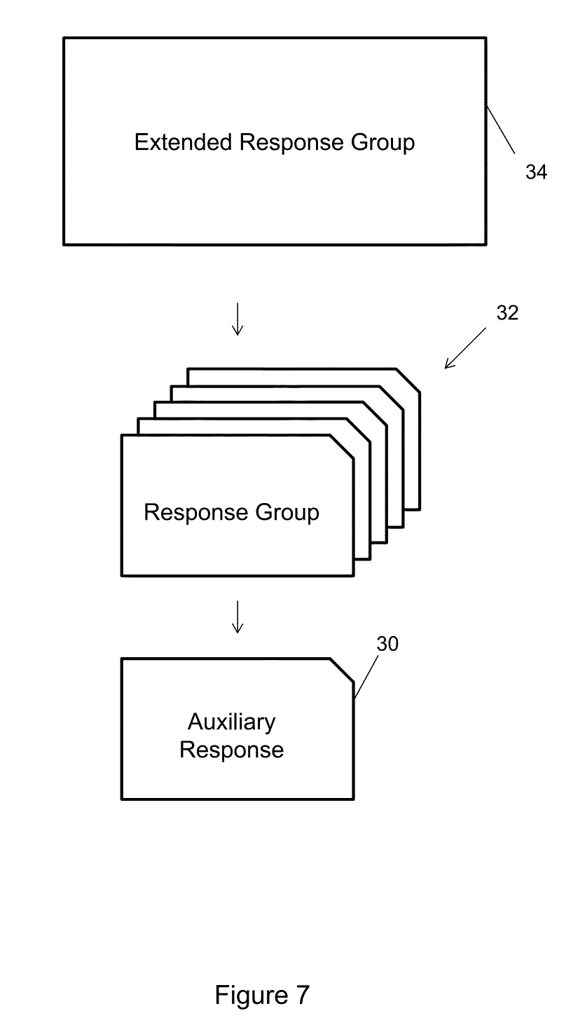

In embodiments, as shown in FIG. 7, the response group 32 can be dynamically generated, and populated with auxiliary responses 30 from an extended response group 34 which meet particular filter requirements, at a filtering step 24 (of FIG. 6). Alternatively, the filtering step 24 is incorporated into the decision making step 23 described below. In this instance, the filtering step 24 is applied to only those auxiliary responses 30 meeting the geographic requirements. Filtering, as used herein, corresponds to selecting auxiliary responses 30 based on further criteria than simply geographic region.

For example, each auxiliary response 30 has, or optionally has, an associated time(s) of day and/or day(s) of week associated with it. It can be that an auxiliary response 30 without a time of day and/or day of week is considered to be applicable to any time of the day and/or day of the week, as appropriate. The time and/or day at which auxiliary response step 22 is performed (response time), or another relevant time such as the real (or estimated) pickup time or real (or estimated) delivery time, is used to filter the possible auxiliary responses 30 of the extended response group 34 such that only those auxiliary responses 30 with an associated time of day and/or day of week encompassing the response time are added to the response group 32.

The decision making step 23 can include any technique for identifying a single auxiliary response 30 for sending to the customer from a plurality of auxiliary responses 30 that meet the geographic requirement, and where applicable, the filtering requirements, discussed above. In one embodiment, one auxiliary response 30 is randomly selected from the plurality of auxiliary responses 30 that otherwise meet the geographic, and where applicable, filtering requirements.

In other embodiments, the decision making step 23 includes a bidding system, wherein different auxiliary entities with auxiliary responses 30 meeting the relevant criteria can bid, preferably using an automated system, to have their auxiliary response 30 selected. In one exemplary bidding system, the auxiliary entities each specify a total amount, a daily amount, and a per message amount, that they are willing to spend (either in total or, optionally, where more than one advertisement is associated with an entity, per advert) on advertising. The total amount and daily amount limit the total cost of adverts that will be sent. The ‘per message’ amount is used in the actual bidding process, and corresponds to the maximum amount each auxiliary entity is prepared to spend in order to have an associated auxiliary response 30 selected.

In an example of a bidding system, the decision making step 23 includes each auxiliary response 30 meeting the relevant criteria (i.e. geographic requirement and, where applicable, the filtering requirement) having bids made for them, for example through an automated system, where, for each auxiliary response 30, the maximum bid which will be placed is equal to the associated ‘per message’ amount. The auxiliary response 30 making the highest bid is selected. The amount paid is the next highest bid below the winning bid, optionally with a further fixed amount added to it, for example one cent.

In embodiments, the decision making step 23 also comprises a weighting factor, which will bias the selection of an auxiliary response 30, for example, to auxiliary entities which are located closer to the pickup location.

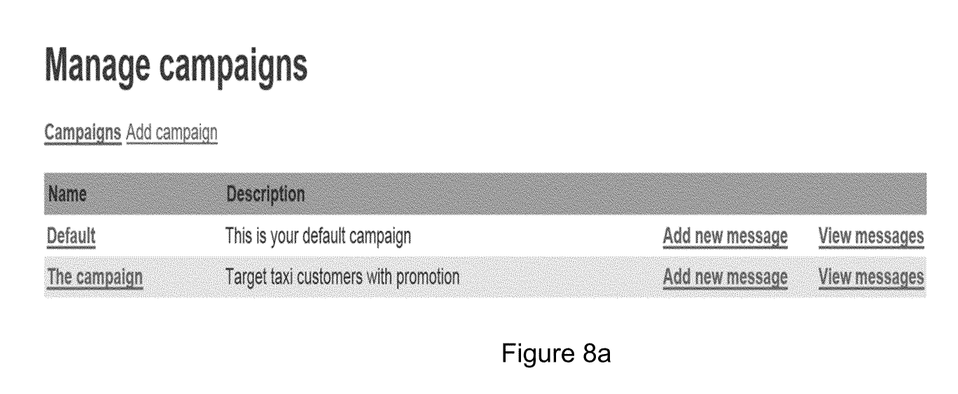

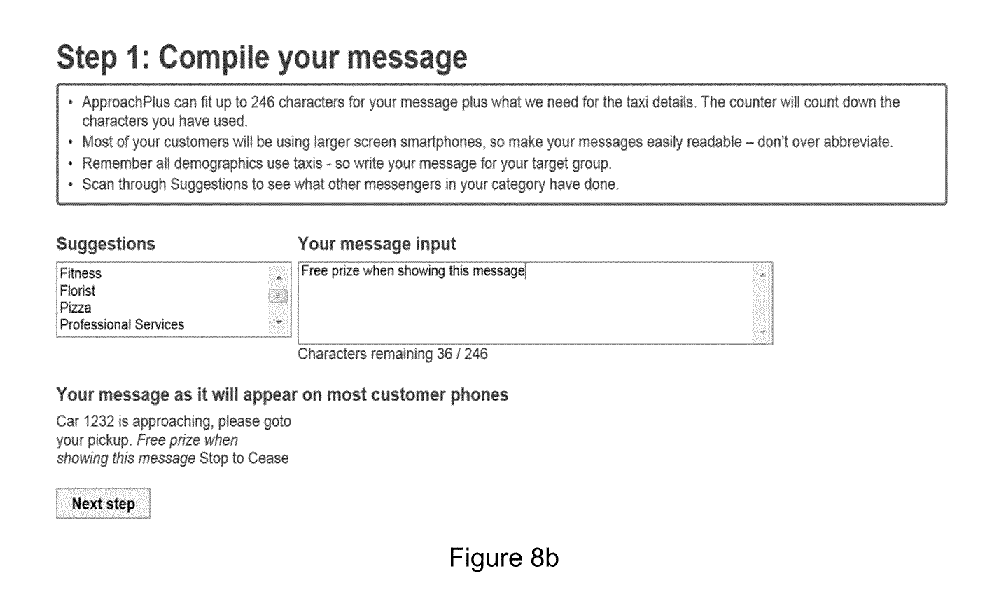

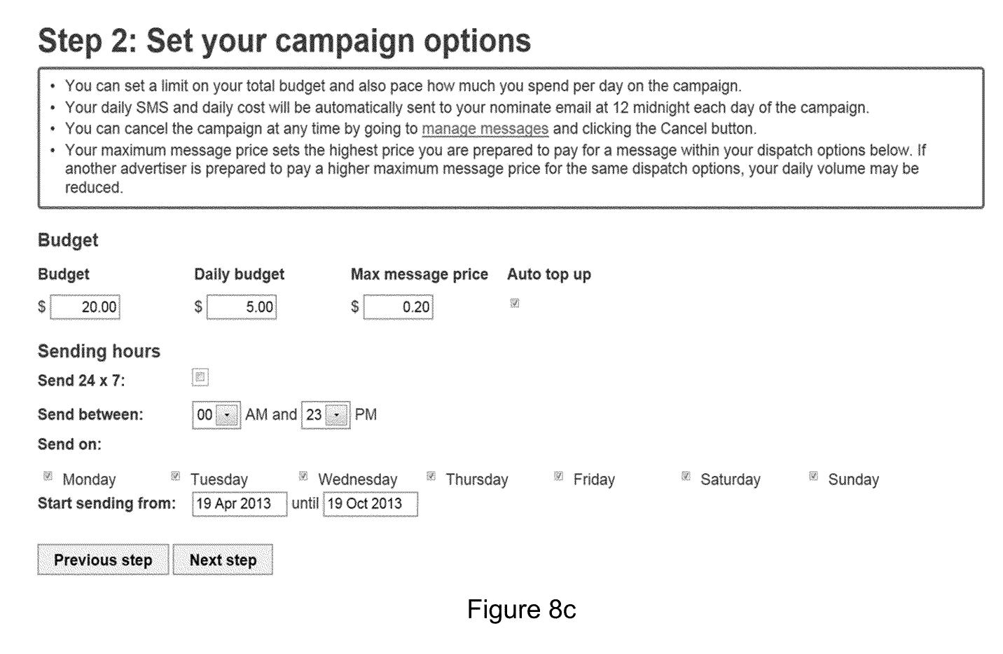

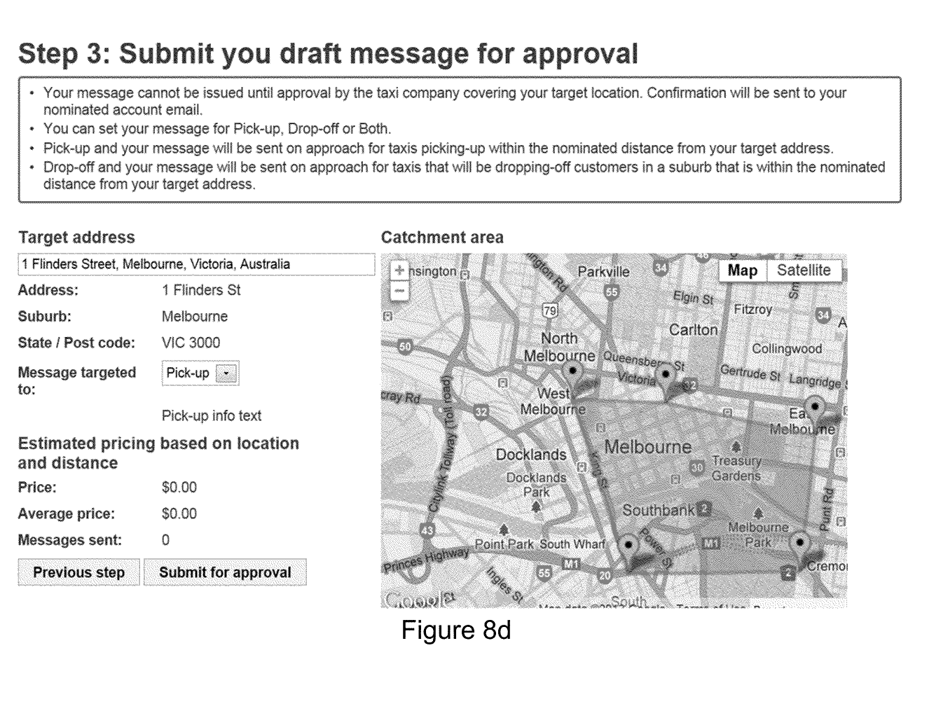

Referring to FIGS. 8a to 8e, there is shown an example method for an auxiliary entity to set up an advertising campaign. The example is for illustrative purposes and is not intended to be limiting. In FIG. 8a, a representative of an auxiliary entity operates a user terminal 52 to create a new auxiliary response 30 by selecting “Add New Message”. In FIG. 8b, text for the auxiliary response 30 is entered into the user terminal 52, where the text will be appended to the SMS arrival alert message. The next step, as shown in FIG. 8c, allows for selection of a total budget for the campaign, a daily budget, and a maximum bid per advert. Also, at this step as shown in the figure, it is possible to select the particular days of the week and times of day in which the advertisement should be considered for selection (i.e. apply filter criteria to the advert). Finally, the step shown in FIG. 8d allows for a geographic region to be selected by selecting a region on a map. This step also allows for selection of whether the pickup, destination, or both locations. The auxiliary response 30 is then submitted for approval, where approval usually corresponds to approval by the primary entity (i.e. the taxi company).

Further modifications and improvements may be made without departing from the scope of the present invention.

The claims defining the invention are as follows:

1. A method for providing an auxiliary response to a user of a primary service and a primary response to the user, the method comprising the steps of:
receiving a request from the user, the request being in respect of the primary service, and comprising location information;
determining the primary response, the primary response based on the location information and the primary service;
determining the auxiliary response, the auxiliary response based on the location information; and
communicating the primary response and the auxiliary response to the user,
wherein the auxiliary response comprises information in respect of an auxiliary entity.

2. A method as claimed in claim 1, wherein the request corresponds to a request for the primary service to be provided by a primary entity.

3. A method as claimed in claim 1, wherein the content of the primary response is independent of the content of the auxiliary response.

4. A method as claimed in claim 1, wherein the primary service is a taxi service, and wherein the primary response is an SMS message informing the user that a taxi of the taxi service is arriving, and wherein the auxiliary response is an advertisement and/or voucher for the auxiliary entity.

5. A method as claimed in claim 1, wherein the primary service is a taxi service, and wherein the primary response is a notification informing the user that a taxi of the taxi service is arriving, and wherein the auxiliary response is an advertisement for the auxiliary entity.

6. A method as claimed in claim 1, wherein the auxiliary response is incorporated into the primary response.

7. A method as claimed in claim 6, wherein the auxiliary response is appended to the primary response.

8. A method as claimed in claim 1, wherein the auxiliary response is sent separately to the primary response.

9. A method as claimed in claim 8, wherein the auxiliary response is sent at or after completion of the primary service.

10. A method as claimed in claim 1, wherein the auxiliary response is determined by selecting an auxiliary response from a response group.

11. A method as claimed in claim 10, wherein each auxiliary response within the response group has an associated geographic region.

12. A method as claimed in claim 11, wherein the auxiliary response with a closest geographic region to the location information is selected.

13. A method as claimed in claim 11, wherein the selection of an auxiliary response comprises a bidding step.

14. A method as claimed in claim 10, wherein the selection of an auxiliary response comprises a filtering step.

15. A method as claimed in claim 14, wherein the filtering step includes the steps of:
identifying a response time associated with the request;
identifying one or more auxiliary responses having an associated time of day and/or day of week corresponding to the response time; and
limiting the response group such that only said identified one or more auxiliary responses are present within the response group.

16. A method as claimed in claim 1, wherein the location information includes a pickup location.

17. A method as claimed in claim 1, wherein the location information includes a destination location.

18. A method as claimed in claim 1, wherein communication of the primary response and auxiliary response to the user includes a wireless communication.

19. A system comprising at least one processor and a memory, wherein the processor is configured for executing instructions stored within the memory, and wherein the memory comprises instructions for:
receiving a request from the user, the request being in respect of the primary service, and comprising location information;
determining a primary response, the primary response based on the location information and the primary service;
determining an auxiliary response, the auxiliary response based on the location information; and
communicating the primary response and the auxiliary response to the user,
wherein the auxiliary response comprises information in respect of an auxiliary entity.
